(19) United States
(12) Patent Application Publication
(10) Pub. No.: US 2007/0214075 A1
(43) Pub. Date: Sep. 13, 2007

(54) AUCTION MANAGEMENT SYSTEM

(76) Inventor: Gerald H. Ablan, Atlanta, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 11/749,490

(22) Filed: May 16, 2007

Related U.S. Application Data
(63) Continuation of application No. 09/644,411, filed on Aug. 23, 2000.

(51) Int. Cl. G06Q 30/00

(52) U.S. Cl. 705/37

(57) ABSTRACT

An auction management system that consolidates auction posting, monitoring, and closing for multiple auction users on multiple auction sites. An auction consolidator provides an Internet interface between auction sellers, auction buyers, and auction sites. The auction management system provides a unified platform where sellers post auction submissions, enter auction tracking data, and enter auction feedback for multiple auctions on multiple auction sites. Similarly, auction buyers monitor auction status, receive winner notification, enter auction tracking data, and enter auction feedback for multiple auctions on multiple auction sites. To support these functions, the auction management system compiles and posts auction submissions, automatically accesses the auction sites to extract auction status and closed auction data, and provides auction feedback to multiple auction sites on behalf of multiple auction users. The auction management system includes several Internet web servers that function as user interface platforms. An application server and a relational database support the integrated operations of the system. The application server includes an “auction monitor” module that maintains a consolidated auction monitoring report for each account maintained on the system. The auction monitor module includes tracking entries that allows auction buyers and sellers to keep track of the status of their closed auctions. The auction monitor module also automates certain post-closing tacking functions, such as notifying the winning bidder, and supports automatic auction feedback to the host auction site.

### TECHNICAL FIELD

This invention relates generally to on-line auction systems and, more particularly, to an auction management system providing for consolidated auction posting and automatic monitoring of multiple auctions on multiple auction sites.

### BACKGROUND OF THE INVENTION

On-line auctions have quickly become one of the most successful Internet applications. The ease of access, wide scope of notice, and low cost of on-line communications makes the Internet a tremendously successful auction platform. So successful, in fact, that the challenge for active auction users is not finding a place to participate in an auction, but effectively monitoring large numbers of auctions. For auction sellers, the process of creating dozens or hundreds of auction submissions and posting them to various auction sites can consume hours. The process can also be tedious to the point of mind numbing.

Periodically logging into the various auction sites to monitor the status of the auctions can be equally time consuming and tedious. And when the auctions close, the process of completing the transactions and providing feedback to the auction host requires more time and effort. A large-scale auction seller can easily get bogged down just trying to keep track of which auctions have closed, which buyers have paid, which packages have been shipped, and so forth. For this reason, the time and effort required to post, monitor, and complete auction transactions represents an important transaction cost that limits the cost effectiveness of the on-line auction vehicle in certain situations, such as the sale of very inexpensive items in a large number of separate transactions.

Similar drawbacks beset auction buyers, and especially those who would like to bid in a large number of auctions. Unless the buyer has sufficient time and motivation to monitor each auction on an on-going basis, it is difficult if not impossible to optimize the bidding strategy. A large scale auction buyer also faces the challenge of tracking which bids have won, which purchases have been paid for, which items have been received, and so forth.

The drawbacks described above tend to inhibit new auction users and limit the usefulness of the on-line auction process for experienced auction users in some situations. For auction users all levels of skill and market activity, there is a need in the art for a more effective auction management tools. In particular, there is a need for an auction management tool that allows easy buyer and seller control over multiple auctions on multiple auction sites. Additional improvements in the on-line auction management process are also needed.

### SUMMARY OF THE INVENTION

The present invention meets the needs described above in an auction management system that provides a consolidated platform for managing multiple auctions posted on multiple auction sites. The auction management system saves auction users time and offers convenience by providing a single site where users can create an auction inventory, store images of the items offered for sale, create auction submissions, and queue them for posting to a variety of auction sites. The auction management system also creates a unified auction monitoring report that keeps track of activity on the user's auctions on multiple auction sites. To do so, the auction management system automatically links to the various auction sites, identifies the user's auctions, and extracts the pertinent data for consolidated display on the auction monitoring report.

The auction management system also provides the added convenience of automatic closed auction processing. For this feature, the auction management system automatically identifies closed auctions, links to the appropriate auction sites, and extracts the pertinent closed auction data. The system then identifies auctions that ended in sales, notifies the buyers and sellers, and creates billing and sales records. The auction monitoring reports also includes tracking fields for entering post-auction data indicating whether the successful bidder has been notified, whether payment has been received, whether the auction item has been shipped, and whether feedback has been sent to the auction host. The system also offers payment handling, a retail electronic store front, automatic feedback handling, one-click incremental bidding, and other time saving features and options.

The consolidation of all of these auction management tools on a single platform greatly facilitates auction processing and monitoring for multiple auctions posted on multiple auction sites. The automatic auction monitoring and consolidated reporting features typically save the auction posting party five to ten minutes for every auction posted, a minute or two for each monitoring update, and five to ten minutes for each completed sale. For a large auction user posting hundreds or thousands of auction per month, the time savings add up to hundreds or even thousands of man hours over the course of a year. The system also makes the auction process easier to use and understand for novice users. Moreover, the advantage of automatic real-time auction updates facilitates more effective bidding and listing practices. The system therefore provides advantages for auction users at all levels of skill and market activity.

Generally described, the auction management system creates an auction consolidation account and receives a number of auction requests in association with the account. Then system then visits each auction site and posts the corresponding auction request. To allow consolidated auction monitoring, the system compiles a consolidated auction monitoring report containing information pertaining to each auction request. Typically upon receiving a user request for an auction monitoring report, the system revisits each auction site to extract updated auction information pertaining to the corresponding auction request. The system then updates the auction monitoring report with the updated auction information extracted from the auction monitoring sites.

To facilitate the creation of auction submissions, the auction management receives auction advertisement text, an auction advertisement image, and a selection of one of a number of predefined auction templates. The system then creates an auction submission by combining the advertisement text and the advertisement images in a format defined by the selected auction template. The system later transmits the auction submission to the auction site in accordance with a posting time instruction received from the posting user.

The auction monitoring feature automatically visits the auction host site for a monitored auction, identifies the page containing the corresponding auction posting; downloads the page, and then parses the page to extract the updated auction information. To facilitate the processing of closed auctions, the system periodically identifies posted auctions that have closed. For each closed auction, the system visits the host auction site, identifies the page containing the closed auction, downloads the page, parses the page to extract the closed auction data, and then processing the closed auction data.

To process the closed auction data, the system typically determines whether the auction resulted in a sale. If so, the system notifies the seller and buyer, and creates sales and billing records documenting the closed auction closing. The system may also obtain an automatic feedback instruction from settings data associated with the corresponding account, and transmit auction feedback data to the corresponding site in accordance with the automatic feedback instruction.

To facilitate auction tracking, the auction monitoring report includes auction tracking fields. The auction user may click on these fields to indicate the completion of a tracked event. For example, the tracked events typically include buyer notification, payment received, auction item shipped, and payment received. To partially automate the tracking process, the system obtains an auction processing instruction from settings data associated with the corresponding account, performs an operation in accordance with the auction processing instruction, and set one of the tracking field to indicate completion of the operation. For instance, the system may automatically notify the buyer upon the closing of an auction ending in a sale, and indicate in the appropriate tracking field that the winning bidder has been notified.

In view of the foregoing, it will be appreciated that the present invention greatly facilitates auction processing and monitoring for multiple auctions posted on multiple auction sites. The specific techniques and structures employed by the invention to improve over the drawbacks of prior on-line auction systems and accomplish the advantages described above will become apparent from the following detailed description of the embodiments of the invention and the appended drawings and claims.

### BRIEF DESCRIPTION OF THE DRAWINGS

FIG. 1 is a functional block diagram of an auction management system.

FIG. 2 is a functional block diagram of an auction consolidator.

FIG. 3 is a functional block diagram illustrating the components used to monitor auctions and finalize sales in an auction management system.

FIG. 4 is a functional block diagram illustrating the components used to post auction submissions in an auction management system.

FIG. 5 is a logic flow diagram illustrating an auction consolidation routine.

FIG. 6 is a logic flow diagram illustrating a routine in which sellers list items for auction.

FIG. 7 is a logic flow diagram illustrating a routine for creating an auction consolidation account.

FIG. 8 is a logic flow diagram illustrating a routine for creating auction inventory.

FIG. 9 is a logic flow diagram illustrating a routine for launching an auction.

FIG. 10 is a logic flow diagram illustrating a routine for posting auction submissions to auction sites.

FIG. 11 is a logic flow diagram illustrating a routine for monitoring auction sites.

FIG. 12 is a logic flow diagram illustrating a routine for finalizing auction sales.

FIG. 13 is a logic flow diagram illustrating a routine for processing closed auctions.

FIG. 14 is a logic flow diagram illustrating a routine for providing auction feedback.

FIG. 15 is a logic flow diagram illustrating a routine for updating a parser for use in an auction monitoring system.

FIG. 16 is an illustration of a user interface containing a seller's auction monitoring report.

FIG. 17 is an illustration of a user interface containing a buyer's auction monitoring report.

### DETAILED DESCRIPTION OF THE EMBODIMENTS

The present invention may be embodied in an auction management system that consolidates auction posting, monitoring, and closing for multiple auction users on multiple auction sites. The system employs an auction consolidator to provide an Internet interface between auction sellers, auction buyers, and auction sites. The auction consolidator provides a unified platform where sellers post auction submissions, enter auction tracking data, and enter auction feedback for multiple auctions on multiple auction sites. Similarly, auction buyers monitor auction status, receive winner notification, enter auction tracking data, and enter auction feedback for multiple auctions on multiple auction sites. To support these functions, the auction management system compiles and posts auction submissions, automatically accesses the auction sites to extract auction status and closed auction data, and provides auction feedback to multiple auction sites on behalf of multiple auction users. The auction consolidator also provides links to one or more payment systems, which offer electronic transaction settlement services to facilitate credit card and debit card payments for completing on-line auction transactions.

An embodiment of the auction management system includes several Internet web servers that function as user interface platforms. An application server and a relational database support the integrated operations of the system. The application server includes a “finalizer” module that identifies and processes closed auctions; a “parser” module that extracts auction status and closed auction data from the auction sites; a “flashpost” module that creates auction submissions and posts them to the auction sites; a “store front” module that allows retail sale access to users' inventories; and an “auction monitor” module that maintains a consolidated auction monitoring report for each account maintained on the system. The auction monitor module typically provides a consolidated auction monitoring for each account. This auction monitoring report includes tracking entries that allows auction buyers and sellers to keep track of the status of their closed auctions. The auction monitor module also automates certain post-closing tacking functions, such as notifying the winning bidder, and supports automatic auction feedback to the host auction site.

The relational database includes a user table containing identification and account information for buyers and sellers that are registered to use the system, an auction table containing status data for all active auctions under management by the system, an inventory table containing specifications for items that registered sellers have inventory, an image inventory containing images for items that registered sellers have inventory; a compilation of auction submission templates, a table of sales records, a table of billing records, and other tables to facilitate the operation of the auction management system.

Those skilled in the art will appreciate that the specific configuration described above could be organized into other equivalent sets of modules and tables that perform the described functions. It should also be understood that, while the system is configured to operate using the Internet as the global communication media, the system could be deployed in other types of networks, such as local or wide area networks, intranets, private dial-up networks, etc. Likewise, the system may be constructed on any of a variety of hardware platforms using any appropriate operating system, database program, and programmer's tool kit. The appropriate size, speed, and capacity of the various components depends on the number of simultaneous users that the system will be designed to support, and such design choices are within the grasp of those of ordinary skill in the programming and networking arts.

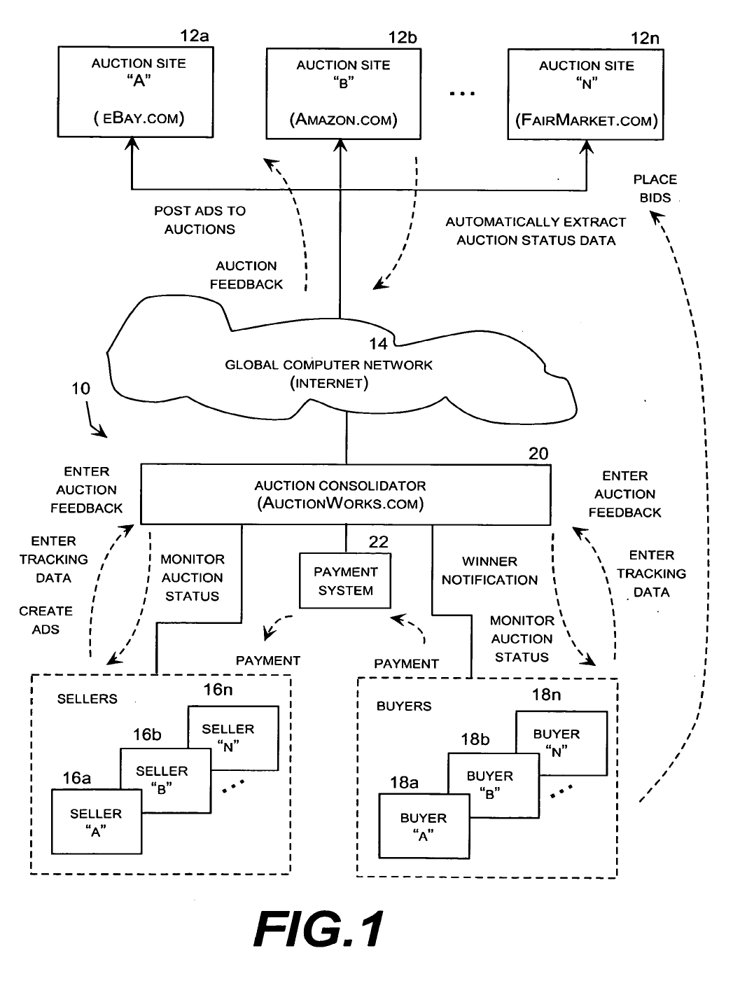

Turning not to the drawings, in which like numerals refer to like elements throughout the several figures, FIG. 1 is a functional block diagram of an on-line auction environment including an auction management system 10. The auction management system 10 includes a consolidated platform, the auction consolidator 20, for accessing and managing auctions conducted on multiple auction sites 12a-12n. The at present, one of the auction sites 12a may be located by eBay.com., another auction site 12b may be located by Amazon.com., another auction site 12n may be located by FairMarket.com., and so forth. The Internet 14 interconnects the auction management system 10 with the auction sites 12a-12n. and with auction sellers 16a-16n and auction buyers 18a-18n. The auction management system 10 also includes one or more payment systems, which is represented by the payment system 22. For example, PayPal.com and several other commercial sites offer electronic transaction settlement services to facilitate credit card and debit card payments for completing on-line auction transactions.

The auction consolidator 20 operates as an Internet interface between the auction sellers 16a-16n, auction buyers 18a-18n and the auction sites 12a-12n. The auction consolidator 20 provides a unified platform where the sellers 16a-16n post auction submissions, enter auction tracking data, and enter auction feedback for multiple auctions the multiple auction sites 12a-12n. Similarly, the auction buyers 18a-18n monitor auction status, receive winner notification, enter auction tracking data, and enter auction feedback for multiple auctions on the multiple auction sites 12a-12n. To support these functions, the auction management system compiles and posts auction submissions, automatically accesses the multiple auction sites 12a-12n to extract auction status and closed auction data, and provides auction feedback to auction sites on behalf of the buyers and sellers. The auction consolidator 20 provides a link to payment system 22, which handles the financial aspects of closing the auction sales,

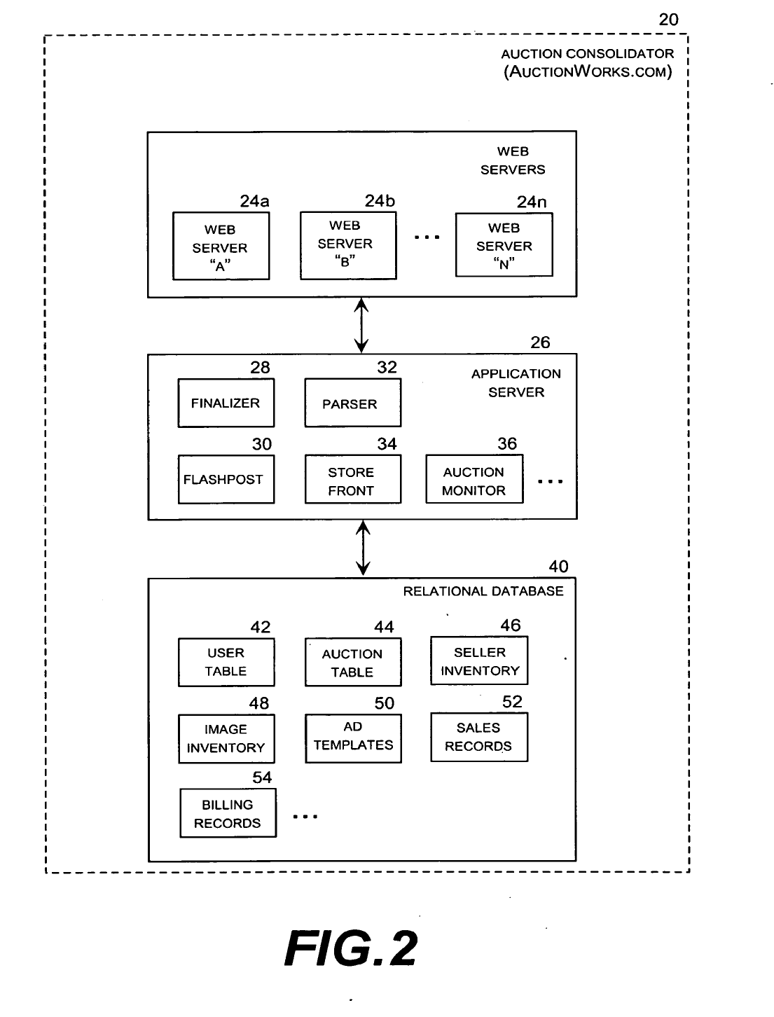

FIG. 2 is a functional block diagram of the auction consolidator 20, which includes several Internet web servers 24a-24n that function as user interface platforms. An application server 26 and a relational database 40 support the integrated operations of the system 10. The application server 26 includes a “finalizer” module 28 that identifies and processes closed auctions; a “parser” module 32 that extracts auction status and closed auction data from the auction sites 12a-12n; a “flashpost” module 30 that creates auction submissions and posts them to the auction sites; a “store front” module 34 that allows retail sale access to users' inventories; and an “auction monitor” module 36 that maintains a consolidated auction monitoring report for each account maintained on the system. The auction monitor module 36 typically provides a consolidated auction monitoring for each account. This auction monitoring report includes tracking entries that allows the auction sellers 16a-16n and the auction buyers 18a-18n to keep track of the status of their closed auctions. The auction monitor module 36 also automates certain post-closing tacking functions, such as notifying the winning bidder, and supports automatic auction feedback to the host auction site.

The relational database 40 includes a user table 42 containing identification and account information for buyers and sellers that are registered to use the auction consolidator 20, an auction table 44 containing status data for active auctions under management by the system 10, an inventory table 46 containing specifications for items that registered sellers have inventory, an image inventory 48 containing images for items that registered sellers have inventory; a compilation of auction submission templates 50, a table of sales records 52, a table of billing records 54, and other tables to facilitate the operation of the auction management system.

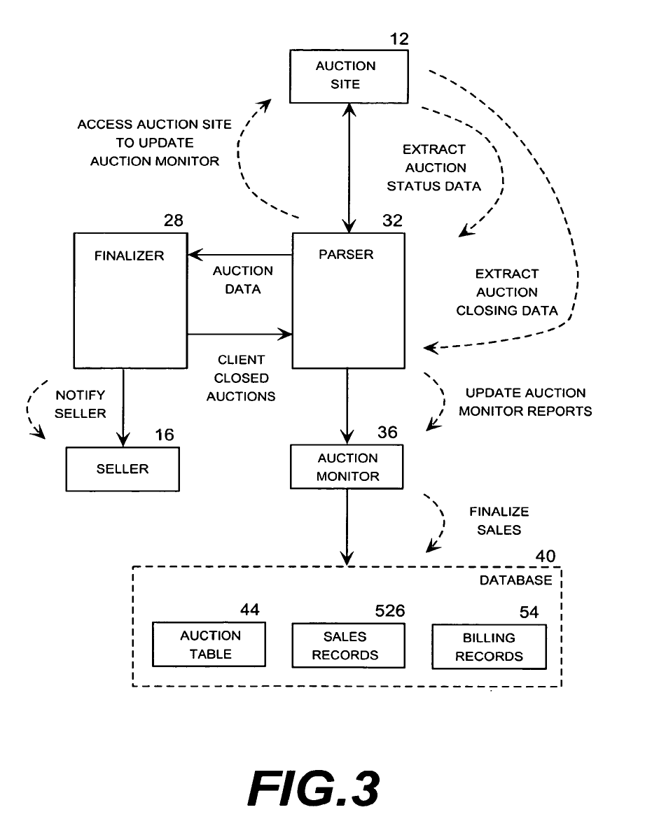

FIG. 3 is a functional block diagram illustrating the components used to monitor auctions in the auction management system 10. Referring first to the process for monitoring active auctions, the auction monitor module 36 automatically obtains updated auction status information for a particular account whenever the auction buyer or seller associated with that account links to the auction monitor module 36 or selects an “update auction monitor” command from within the auction monitor module. To obtain the updated auction status information for a particular active auction, the auction monitor 36 links to the host auction for that auction. The parser module 32 then navigates to the page that contains the desired auction status data, and downloads that page. The parser module 32 then parses the downloaded page to extract the desired auction status data. The auction monitor 36 uses the extracted auction status data to update the auction monitoring report for the corresponding account. The auction monitor 36 repeats this process for each active auction record in the user's auction monitoring report, and displays the updated auction monitoring report as an HTML web page.

Referring now to the process for finalizing sales, the finalizer module 28 periodically searches the auction table 44 to identify closed auctions. For each closed auction, the finalizer module 28 links to the host auction site 12 and logs in as the seller of the item that had been offered for sale in the closed auction. The finalizer module 28 then navigates to the page that contains the desired closed auction data, and calls the parser module 32 to download that page. The parser module 32 then parses the downloaded page to extract the desired auction closing data. The finalizer module 28 then notifies the seller of the auction closing, typically by e-mail. If the auction closed in a sale, the finalizer module 28 also notifies the winning bidder and creates a sales record and a billing record for the transaction. The sales record keeps track of the closed auction data for post-closing tracking, and the billing record initiates the invoicing process for charging the commission earned by the auction management system 10 for the closed auction. The finalizer module 28 repeats this process for each closed auction record in the auction table 44, rests for a minute, and then begins the process again.

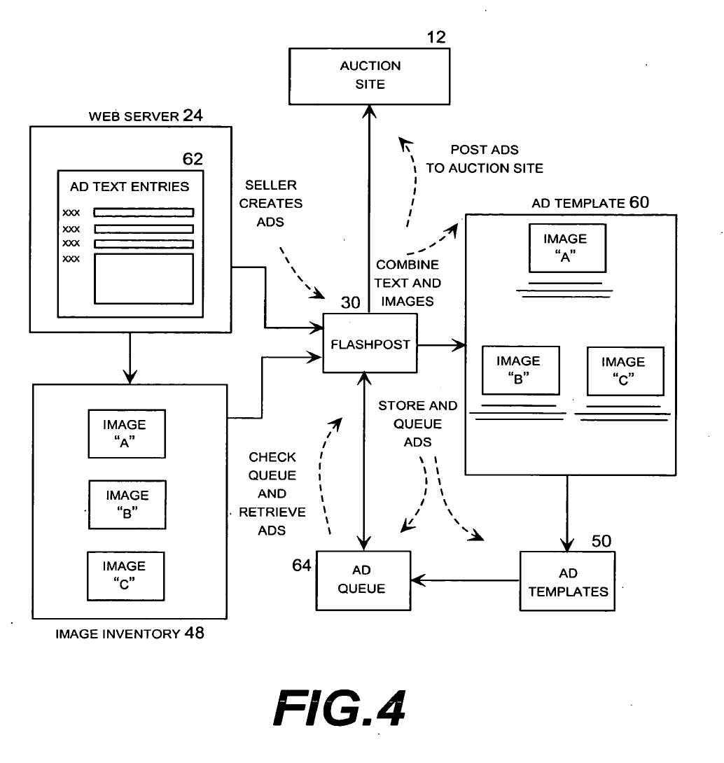

FIG. 4 is a functional block diagram illustrating the components used to post auction submissions in the auction management system 10. A seller in a forward auction, or a buyer in a reverse auction, accesses the system 10 through the web server 24, where a menu-driven user interface system takes the user through the registration and account set-up procedure. The interface system also prompts the user to identify the desired host auction site and the auction parameters. These parameters typically include the date and time to post the item to the auction, the days in the auction or the auction end data and time, the listing category on the host auction site, the payment method, the shipping method, a minimum bid, the reserve price, and a private auction indicator.

Either before or during this session, the user may upload one or more images corresponding to inventory items that the user may want to buy or sell. These images are stored in the image inventory 48. To create an auction submission, also called an “ad,” the user selects a predefined ad template for the ad and fills in the ad text entries on a corresponding HTML page 62 provided by the web server 24. The ad template defines a particular layout for the ad. The user also links the ad to one or more images in the image inventory 48. Upon receipt of a “create ad” command, the flashpost module 30 combines the selected images with the received text to create an HTML page containing the complete auction ad 60. This as is then stored on the ad templates library 50 in the database 40, and the ad is registered in an ad queue 64 for posting to the specified auction at the specified time. The flashpost module 30 periodically checks the ad queue and posts the auction ad to the designated auction site 12 at the specified time.

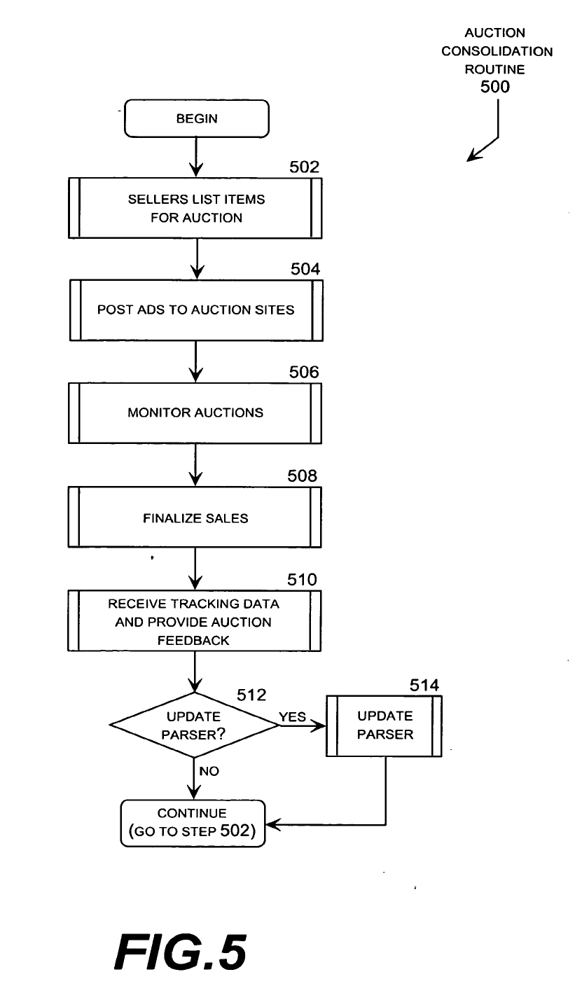

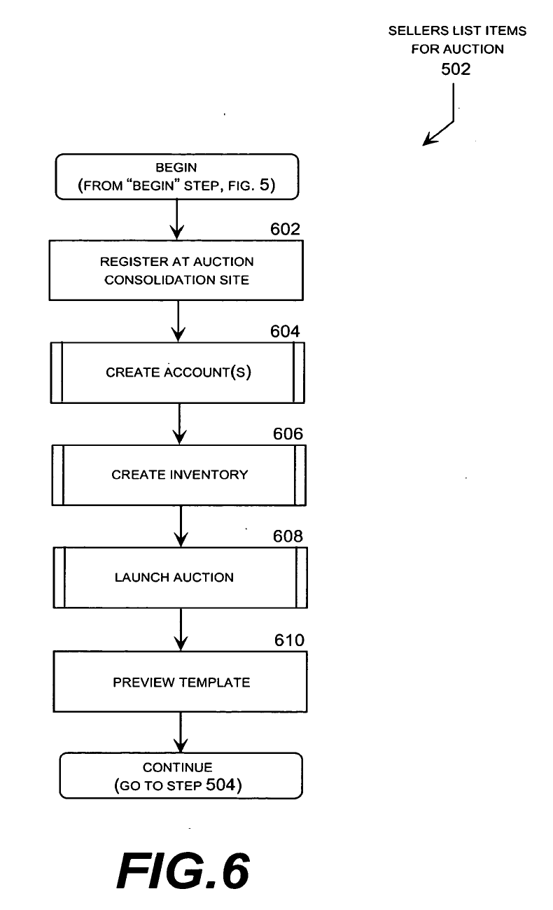

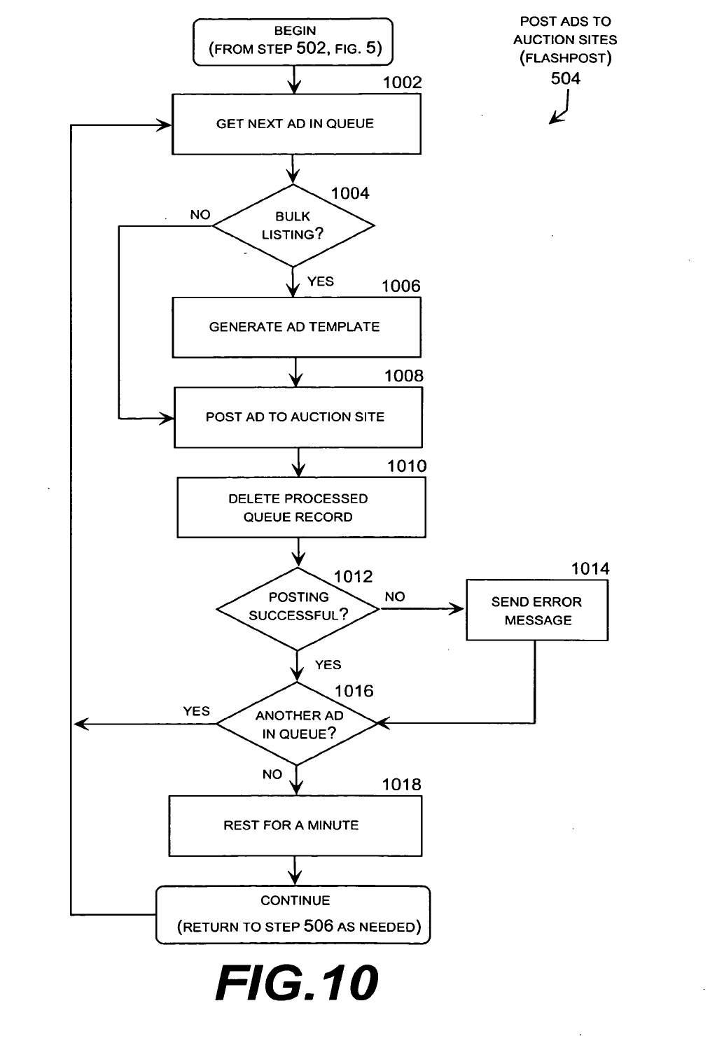

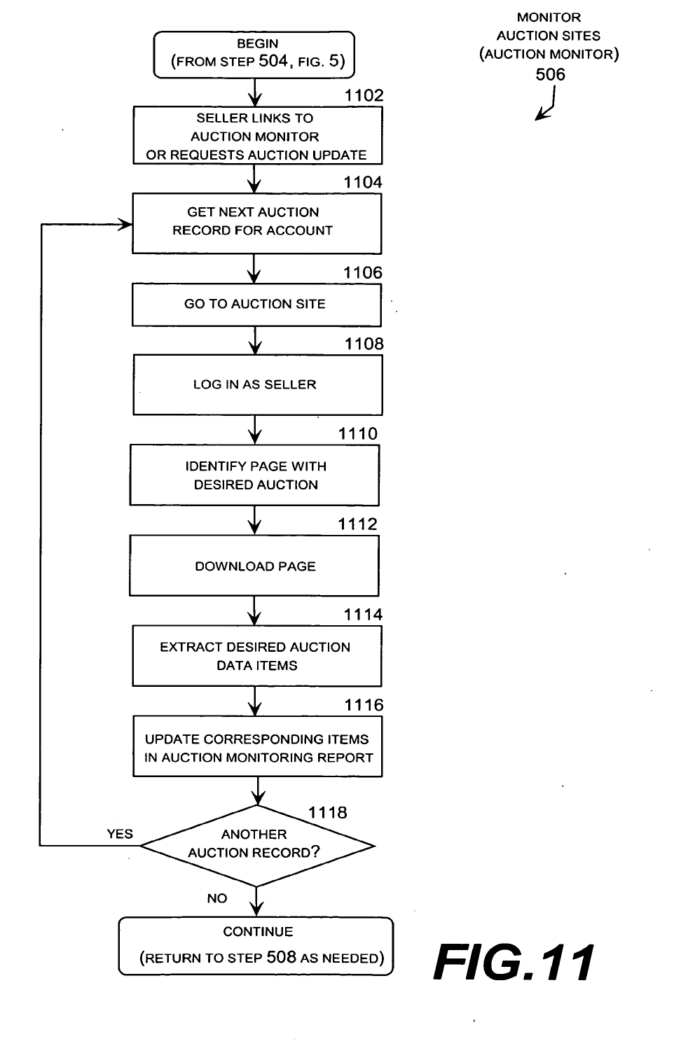

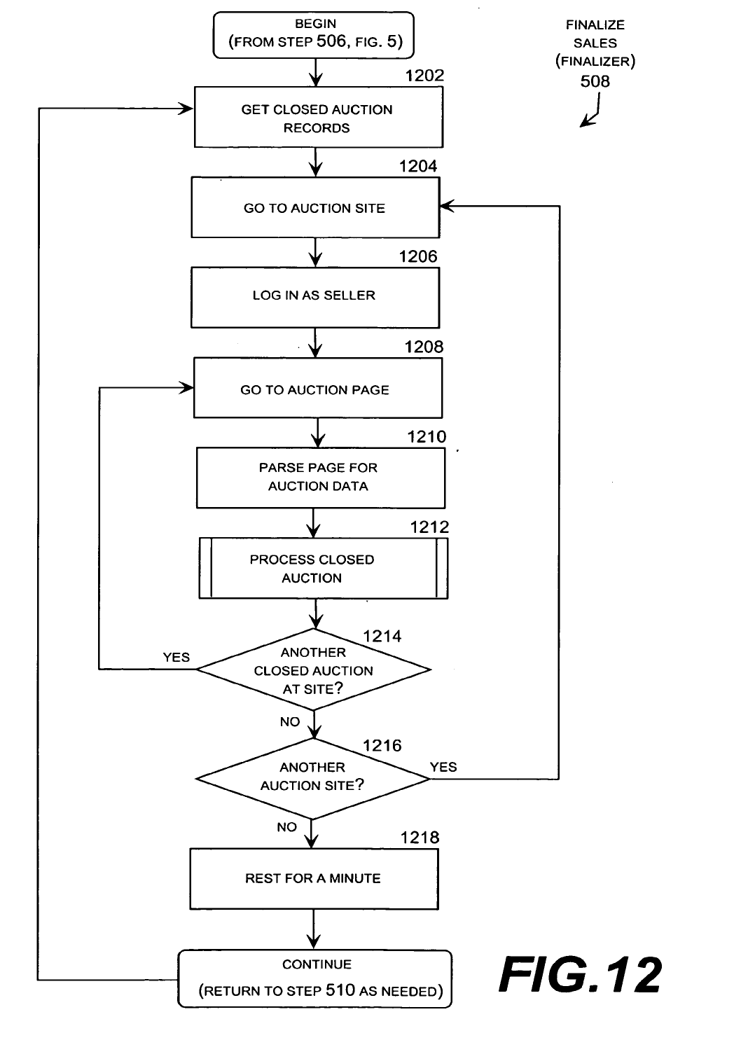

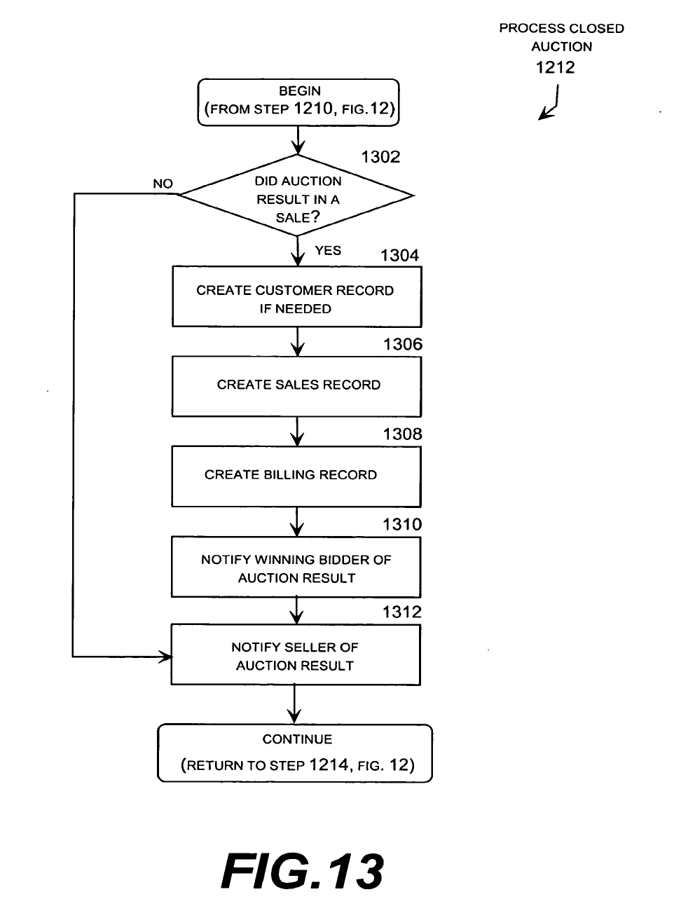

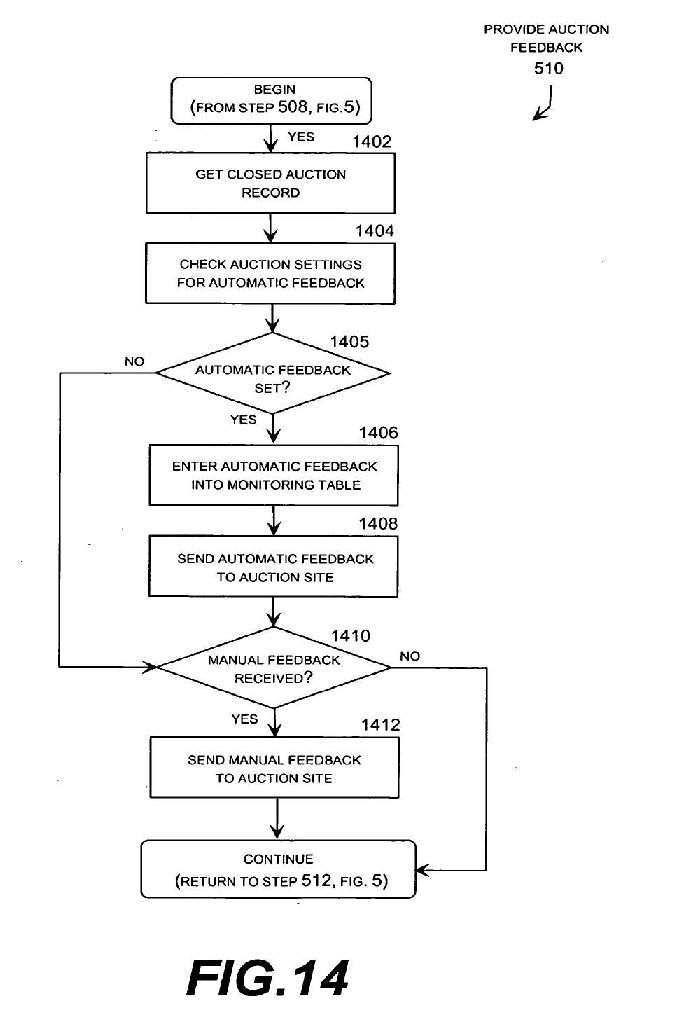

FIG. 5 is a logic flow diagram illustrating an auction consolidation routine for the auction consolidator 20. In routine 502, sellers list items for auction. It will be appreciated that buyers may also list items for a reverse auction. Routine 502 is described in greater detail with reference to FIGS. 6-9. Routine 502 is followed by routine 504, in which the auction consolidator 20 posts auction ads the suction sites. Routine 504 is described in greater detail with reference to FIG. 10. Routine 504 is followed by routine 506, in which the auction consolidator 20 monitors active auctions. Routine 506 is described in greater detail with reference to FIG. 11. Routine 506 is followed by routine 508, in which the auction consolidator 20 finalizes sales. Routine 508 is described in greater detail with reference to FIGS. 12-13. Routine 508 is followed by routine 510, in which the auction consolidator 20 receives auction tracking data and provides feedback to the host auction sites. Routine 510 is described in greater detail with reference to FIG. 14.

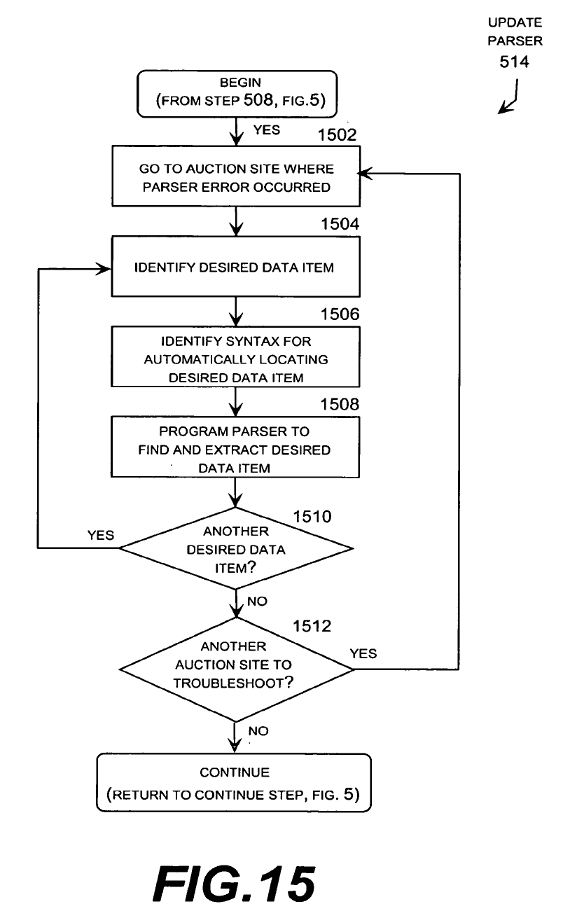

Routine 510 is followed by decision step 512, in which the auction consolidator 20 decides whether to update the parser module 32. This module may need updating whenever the host auction site alters the structure of the HTML pages on the auction site that the parser extracts auction status monitoring or closed auction data. For example, an auction data download error may indicate the need to update the parser. If the parser module 32 needs to be updated, the “YES” branch is followed to routine 514, in which a technician updates the parser module 32. Routine 514 is described in greater detail with reference to FIG. 15. If the parser module 32 does not need to be updated, the “NO” branch is followed to the “CONTINUE” step, which returns to step 502. That is, routine 500 may repeat as needed during the operation of the auction consolidator 20.

Although routine 500 is illustrated as a linear progression, it should be appreciated that each of the constituent routines 502-514 may operate independently and simultaneously. That is, routine 500 shows the usual progression for a particular auction, but as multiple auctions are processed by multiple users, any or all of the constituent routines 502-514 may be operating at any particular time. In particular, routines 504 and 508 typically operate in a continuous loop, whereas routine 502 operates whenever a seller lists an item. Routine 506 operates on an account-by-account whenever a user links to the auction monitor 36 for a particular account. In other words, routine 506 operates for a particular account whenever a user links to the auction monitor 36 for that particular account. Routine 510, on the other hand, typically operates in part automatically whenever an auction closes, and in part manually as buyers and sellers enter tracking data. And routine 514 operates from time to time whenever the parser 32 needs updating in response to changes that occurred to one or more of the auction sites.

FIG. 6 is a logic flow diagram illustrating routine 502 in which sellers list items for auction. It should be understood that routine 502 operates in an equivalent matter for buyers in reverse auctions. Routine 502 follows the “BEGIN” step shown on FIG. 5. In step 602, a seller registers at the auction consolidator site 20. The registration information typically includes user information and seller information. The user information typically includes desired user name, desired password, e-mail address, and a “where did you hear about us” selection menu. The seller information typically includes a billing address and information authorizing a payment method, such as a credit or debit card account. Upon receiving the requested information, the auction consolidator site 20 typically displays the received user profile and offers the user an opportunity to review and edit the information as desired.

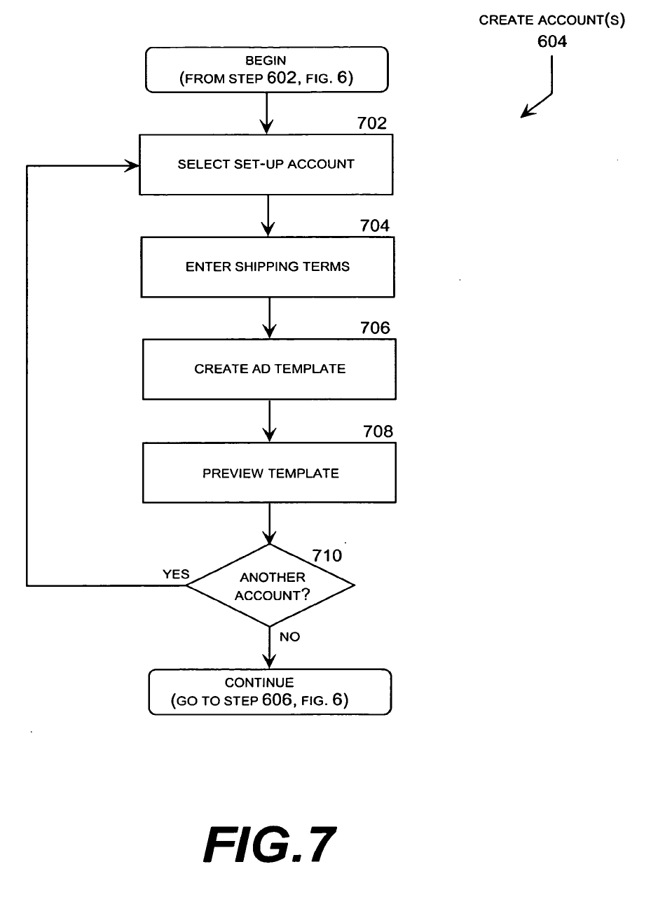

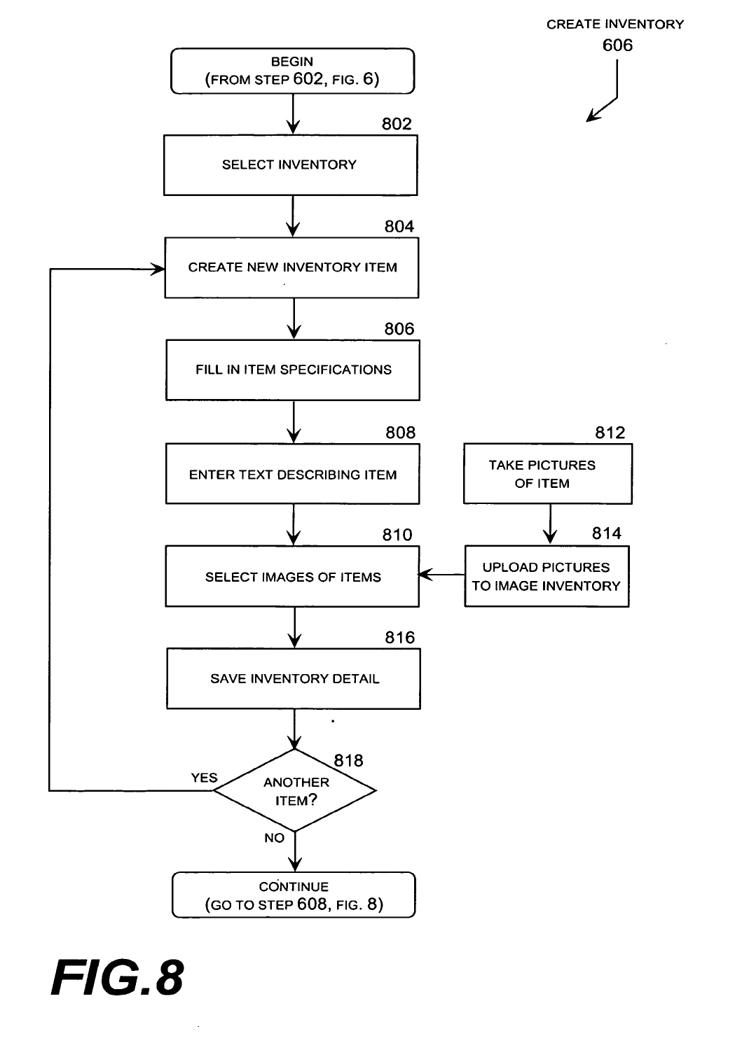

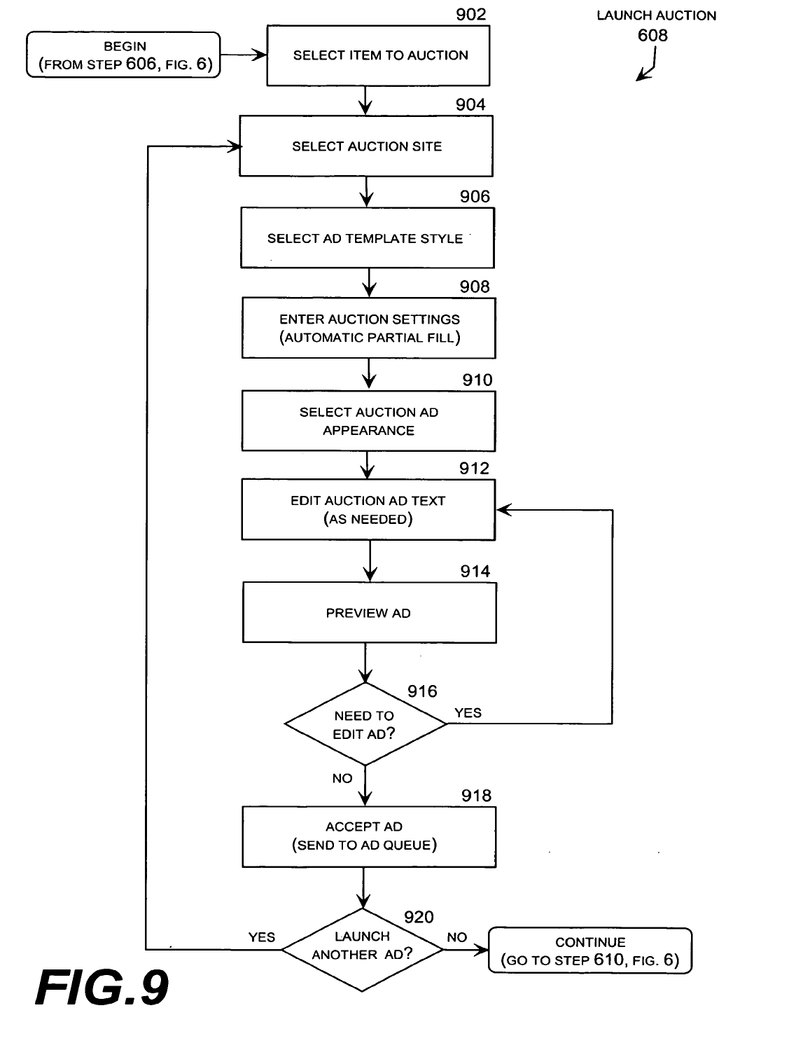

Step 602 is followed by routine 604, in which the seller creates one or more auction accounts. Routine 604 is described in greater detail with reference to FIG. 7. Routine 604 is followed by routine 606, in which the seller creates auction inventory. Routine 606 is described in greater detail with reference to FIG. 8. Routine 606 is followed by routine 608, in which the seller launches an auction. Routine 608 is described in greater detail with reference to FIG. 9. Routine 608 is followed by step 610, in which the seller previews the auction template and may make changes if desired. Step 610 is followed by the “CONTINUE” step, which returns to step 504 shown on FIG. 5.

FIG. 7 is a logic flow diagram illustrating routine 604 for creating an auction consolidation account. Routine 604 follows step 602 shown on FIG. 6. In step 702, the seller selects a “set-up account” option. Step 702 is followed by step 704, in which the seller enters default shipping terms for the account. In this step, the auction consolidator site 20 displays a semi-structured user interface that prompts the seller to enter certain default shipping terms. These terms typically include whether the buyer or seller will pay for shipping, what the shipping cost will be, and the payment terms (e.g., by credit card, personal checks accepted within ten days, and so forth). The auction consolidator site 20 then creates a text paragraph containing the default shipping terms as they would be published on the ad template, and allows the seller to preview and edit the paragraph.

Step 704 is followed by step 706, in which the seller creates an ad template for the account. In this step, the auction consolidator site 20 displays a semi-structured user interface that prompts the seller to enter selection items that define an ad template. These terms typically include a template style selection, a title for the item, a description of the item, a specification of shipping terms (e.g., use the default shipping terms), and one or more optional image legends for each image in the selected template style. The auction consolidator site 20 then creates the HTML code for the ad template, and allows the seller to preview and edit the HTML code.

Step 706 is followed by step 708, in which the seller previews the ad template. In this step, the auction consolidator site 20 displays the ad template as it will appear on the auction site. The seller may then save the ad template or repeat one or more of the previous steps edit the ad template. Once the seller is satisfied with the ad template for the current account, the user may decide in step 708 whether to create another auction account. If the seller wants to create another account, the “YES” branch loops back to step 702, in which the seller selects the “set-up account” option. If the seller does not want to create another account, the “NO” branch is followed to the “CONTINUE” step, which returns to step 606 shown on FIG. 6.

FIG. 8 is a logic flow diagram illustrating a routine 606 for creating auction inventory. Routine 606 follows routine 604 shown on FIG. 6. In step 802, the seller selects a “set-up inventory” option. Step 802 is followed by step 804, in which the seller creates a new inventory item. Alternatively, the seller may edit or delete an inventory item at this point. In this step, the auction consolidator site 20 displays a semi-structured user interface that prompts the seller to enter certain inventory detail items. Step 804 is followed by step 806, in which the seller fills in the inventory detail items. These items typically include the item inventory number, the item's title, the quantity on hand, the quantity on hold, shipping terms for single and multiple item deliveries, a directory location or folder for storing the inventory detail, the auction categories at the various auction sites for listing the item, the acquisition cost of the item, the retail price of the item, an indication whether the item is offered for sale on the seller's store front, a minimum opening bir, a reserve price, and a description of the item. Additional data items may include keywords for search use on the auction sites, storage locations for optional images of the item, and other optional data, such as an ISBN number, UPC code, SKU number, color, item release or manufacture date, style or model, size, dimensions, weight, and so forth. Step 806 is followed by step 808, in which the seller enters a free-text description of the item.

Either previously or at this point the seller may take digital pictures of the item in step 812 and upload them to the image inventory 48 in step 814. Steps 808 and 814 are followed by step 810, in which the seller selects one or more images from the image inventory 48 to be displayed along with the text in the ad template. The auction consolidator site 20 then creates an inventory detail page containing the received data, and allows the seller to preview and edit the inventory detail page. The seller may then save the inventory detail or repeat one or more of the previous steps edit the inventory detail. Once the seller is satisfied with the inventory detail, steps 810 is followed by step 816, in which the seller saves the inventory detail. The user may then decide in step 818 whether to create another inventory item. If the seller wants to create another inventory item, the “YES” branch loops back to step 804, in which the seller selects the “create new inventory item” option. If the seller does not want to create another inventory item, the “NO” branch is followed to the “CONTINUE” step, which returns to routine 608 shown on FIG. 6.

FIG. 9 is a logic flow diagram illustrating routine 608 for launching an auction. Routine 608 follows routine 606 shown on FIG. 6. In step 902, the seller selects an item from the auction inventory and enters a “launch” command. This brings up a semi-structured user interface that prompts the seller to enter or select certain auction launch items. Step 902 is followed by step 904, in which the seller selects an auction site for posting the auction. Step 904 is followed by step 906, in which the seller selects an ad template for the auction ad. In this step, the seller may typically select among a number of predefined ad template styles, including those template styles previously created and saved by the seller in routine 604. Step 906 is followed by step 908, in which the seller enters auction settings, such as the launch date and time, the auction category, and so forth. The fields for these items may already be populated with the data entered by the seller in routine 606. Step 908 is followed by step 910, in which the seller selects an auction ad appearance, which typically sets a color scheme for the ad template.

Step 910 is followed by step 912, in which the seller has an opportunity to review and change the auction settings as desired. Step 912 is followed by step 914, in which the seller may preview the ad template as it will be posted on the auction site. Step 914 is followed by step 916, in which the seller may elect to edit the ad template. If the seller wants to edit the ad template, the “YES” branch loops back to step 912, in which the seller edits the ad template as desired. If the seller does not want to create another inventory item, the “NO” branch is followed to step 918, in which the seller accepts the auction submission. This registers the auction submission in the ad queue 62 (see FIG. 4) for subsequent posting to the auction site in accordance with the posting instructions entered into the as settings. Step 918 is followed by the “CONTINUE” step, which returns to routine 610 shown on FIG. 6.

FIG. 10 is a logic flow diagram illustrating routine 504 for posting auction submissions to auction sites. Routine 504 follows routine 502 shown on FIG. 5. In step 1002, the flashpost module 30 gets the next auction submission registered in the ad queue 62. That is, the auction submissions are queued in order according to the posting time specified in the auction settings, and when the time comes to post a particular auction, the flashpost module 30 gets that auction submission from the ad queue 62. Step 1002 is followed by step 1004, in which the flashpost module 30 determines whether the auction submission is a single item listing or a bulk listing. A single item listings are accompanied by a completed ad template, whereas the flashpost module 30 creates the template for a bulk listing item at this point. Thus, if the auction submission is a bulk listing, the “YES” branch is followed to step 1006, in which the flashpost module 30 creates the template in the manner described previously with reference to FIG. 4. To accommodate this, the bulk listing should contain the ad template style, text description, image selections, shipping terms, and other items, either explicitly or through default settings, required for the flashpost module 30 to create the specific ad template for the particular auction item.

Step 1006 and the “NO” branch from step 104 are followed by step 1008, in which the flashpost module 30 posts the auction submission to the auction site designated in the auction settings. This typically involves automatically logging into the auction site as the seller and properly navigating through HTML pages of the auction site to enter the auction submission. Note here that the execution code for the flashpost module 30 may have to be updated from time to time in response to changes that occur in the auction site logic. Step 1008 is followed by step 1010, in which the flashpost module 30 deletes the just-processed record from the ad queue 62. Step 1010 is followed by step 1012, in which the flashpost module 30 determines whether the auction submission was accepted by the auction site. This is typically determined through a message received from the auction site after the auction site processes the auction submission. If the auction submission was not accepted by the auction site, the “NO” branch is followed to step 1014, in which the flashpost module 30 sends the seller an error message, and may also create a maintenance record to trigger a troubleshooting analysis of the code for the flashpost module 30.

Step 1014 and the “YES” branch from step 1012 are followed to step 1016, in which the flashpost module 30 determines whether the ad queue includes another auction submission that is ready for posting. If the ad queue does include another auction submission to be posted, the “YES” branch loops back to step 1002, in which the flashpost module 30 gets the next ad in the queue. If the ad queue does not include another auction submission to be posted, the “YES” branch is followed to step 1018, in which the flashpost module 30 rests for a minute or some other predetermined or dynamically determined interval. Step 1018 is followed by the “CONTINUE” step, which returns to step 506 shown on FIG. 5. In addition, routine 504 loops back to step 1002 after the rest interval to check for additional auction submissions to post.

FIG. 11 is a logic flow diagram illustrating routine 506 for monitoring auction sites. Routine 506 follows routine 504 shown on FIG. 5. In step 1002, a registered buyer or seller (i.e. user) links to the auction monitor module 36 or selects and “update auction” command from within the auction monitor module 36. Note that the user typically links to the auction monitor module 36 after selecting a particular account, or may be prompted to select an account to monitor at this point. That is, the auction monitor module 36 typically operates on an account-by-account basis, and therefore seeks a specific account. The auction monitor module 36 then obtains or assembles the auction monitor report for that account. The auction monitor includes a record for each active auction associated with the account. These records are then updated for presentation to the user.

Step 1102 is followed by step 1104, in which the auction monitor module 36 gets the next active auction record from the auction monitor report for the current account. Step 1104 is followed by step 1106, in which the auction monitor module 36 links to the host auction site for the current record. That is, the auction monitor module 36 links to the auction site where the item for the current record is on auction. Step 1106 is followed by step 1108, in which the auction monitor module 36 logs in as the seller of the item (or the buyer in a reverse auction). Step 1108 is followed by step 1110, in which the auction monitor module 36 navigates to the page containing the auction status data for the current record. Note here that the execution code for the auction monitor module 36 may have to be updated from time to time in response to changes that occur in the auction site logic. Step 1110 is followed by step 1112, in which the auction monitor module 36 calls the parser module 32 to download that page. Step 1112 is followed by step 1114, in which the parser module 32 parses the downloaded page to extract the auction status data. Step 1114 is followed by step 1116, in which the auction monitor module 36 enters the auction status data as needed to update the auction monitoring report for the current record.

Step 1116 is followed by step 1118, in which the auction monitor module 36 checks the current auction monitoring report and determines whether there is another active auction record to update. If there is another active auction record to update, the “YES” branch loops back to step 1104, in which the auction monitor module 36 gets the next active auction record for the current auction monitoring report. If the current auction monitoring report does not include another active auction record to update, the “NO” branch is followed to the “CONTINUE” step, which returns to routine 508 shown on FIG. 5.

FIG. 12 is a logic flow diagram illustrating a routine 508 for finalizing auction sales. Routine 508 follows routine 504 shown on FIG. 5. In step 1202, the finalizer module 28 gets the next closed auction record from the auction table 44. That is, the finalizer module 28 sorts the auction records in the auction table 44 according to the auction closing time, identifies auctions that have closed, and selects the next closed auction for processing. Step 1202 is followed by step 1204, in which the finalizer module 28 links to the host auction site for the current closed auction record. That is, the finalizer module 28 links to the auction site where the item for the closed auction identified in the current closed auction record was on auction. Step 1204 is followed by step 1206, in which the finalizer module 28 logs in as the seller of the item (or the buyer in a reverse auction). Step 1206 is followed by step 1208, in which the finalizer module 28 navigates to the page containing the auction status data for the current record. Note here that the execution code for the finalizer module 28 may have to be updated from time to time in response to changes that occur in the auction site logic.

Step 1208 is followed by step 1210, in which the auction monitor module 36 calls the parser module 32 to download that page. Step 12 is followed by routine 1212, in which the parser module 32 parses the downloaded page to extract the auction status data. Routine 1212 is described in greater detail with reference to FIG. 13. Routine 1212 is followed by step 1214, in which the finalizer module 28 determines whether there is another closed auction at the same auction site. Note that the finalizer module 28 may sort the closed auction records by auction site to facilitate this aspect of routine 508. If there is another closed auction at the same auction site, the “YES” branch loops back to step 1208 in which the finalizer module 28 links to the corresponding page in the auction site.

If there is not another closed auction at the same auction site, the “NO” branch is followed to step 1216, in which the finalizer module 28 determines whether there are additional closed auction records to process at a different auction site. If there is another closed auction at a different auction site, the “YES” branch loops back to step 1202, in which the finalizer module 28 links to the corresponding auction site. If there is not another closed auction record to process, the “NO” branch is followed to step 1218 in which the finalizer module 28 rests for a minute. Step 1218 is followed by the “CONTINUE” step, which returns to routine 510 shown on FIG. 5.

FIG. 13 is a logic flow diagram illustrating routine 1212 for processing closed auctions. Routine 1212 follows step 1210 shown on FIG. 12. In step 1302, the finalizer module 28 determines whether the closed auction resulted in a sale. If the closed auction did not result in a sale, the “NO” branch loops down to step 1312, in which the finalizer module 28 notifies the seller (or the buyer in a reverse auction) of the auction result. If the closed auction resulted in a sale, the “YES” branch list followed to step 1304, in which the finalizer module 28 creates a customer record for the seller (or the buyer in a reverse auction). The customer record serves as a aggregation item or folder for billing records for that particular customer in the sales billing records table 54.

Step 1304 is followed by step 1306, in which the finalizer module 28 creates a sales record documenting the sale and stores the sales record in the sales record table 52. Step 1306 is followed by step 1308, in which the finalizer module 28 creates a billing record for charging the seller (or buyer, or both, as appropriate) for the auction management system's commission the sale, and stores the billing record in the billing record table 54. Step 1308 is followed by step 1308, in which the finalizer module 28 notifies the wining bidder (i.e., the buyer in a forward auction, and the seller in a reverse auction) of the auction result. Step 1310 is followed by step 1312, in which the finalizer module 28 notifies the seller (or the buyer in a reverse auction) of the auction result. Step 1312 is followed by the “CONTINUE” step, which returns to step 1214 shown on FIG. 12.

FIG. 14 is a logic flow diagram illustrating routine 510 for providing auction feedback. Routine 510 follows routine 508 shown on FIG. 5. In step 1402, the finalizer module 28 gets the next closed auction record from the auction table 44. Step 1402 is followed by step 1404, in which the finalizer module 28 checks the auction settings in the record to determine whether an automatic feedback option is activated. If an automatic feedback option is not activated, routine 510 typically loops to step 1410, where manual feedback may be received. If an automatic feedback option is activated, step 1404 is followed by step 1406, in which the finalizer module 28 enters an indication in the corresponding auction monitoring report indicating that the automatic feedback option is active. Step 1406 is followed by step 1408, in which the finalizer module 28 automatically sends the indicated feedback to the host auction site.

Step 1408 is followed by step 1410, in which the auction monitor 36 may receive manual auction feedback from a user. If the auction monitor 36 receives manual auction feedback, the “YES” branch is followed to step 1412, in which the auction monitor 36 sends the indicated feedback to the host auction site. The “NO” branch from step 1410 and step 1412 are followed by the “CONTINUE” step, which returns to step 512 shown on FIG. 5.

FIG. 15 is a logic flow diagram illustrating routine 514 for updating the parser module 32. Routine 514 follows the “YES” branch from step 512 shown on FIG. 5. In step 1502, a technician troubleshooting the parser module 32 links to the auction site where the parser error occurred. Step 1502 is followed by step 1504, in which the technician identifies a desired data item to extract on the auction site. Step 1504 is followed by step 1506, in which the technician identifies the syntax within the HTML for automatically locating the desired data item. Step 1506 is followed by step 1508, in which the technician programs the parser module 32 to use the identified syntax to identify and extract the desired data item, if needed. Step 1508 is followed by step 150, in which the technician determines whether there is another data item to extract. If there is another data item to extract, the “YES” branch loops back to step 1504, in which the technician identifies the desired data item. If there is not another data item to extract, the “NO” branch is followed by the “CONTINUE” step, which returns to the “CONTINUE” step shown on FIG. 5.

It should be understood that a process similar to that described above may be used to trouble the parser 32 for extracting auction status data, and for extracting closed auction data. In addition, a similar process may be used to troubleshoot the finalizer module 28, the flashpost module 30, and the auction monitor module 36 for any navigation errors that may occur from time to time.

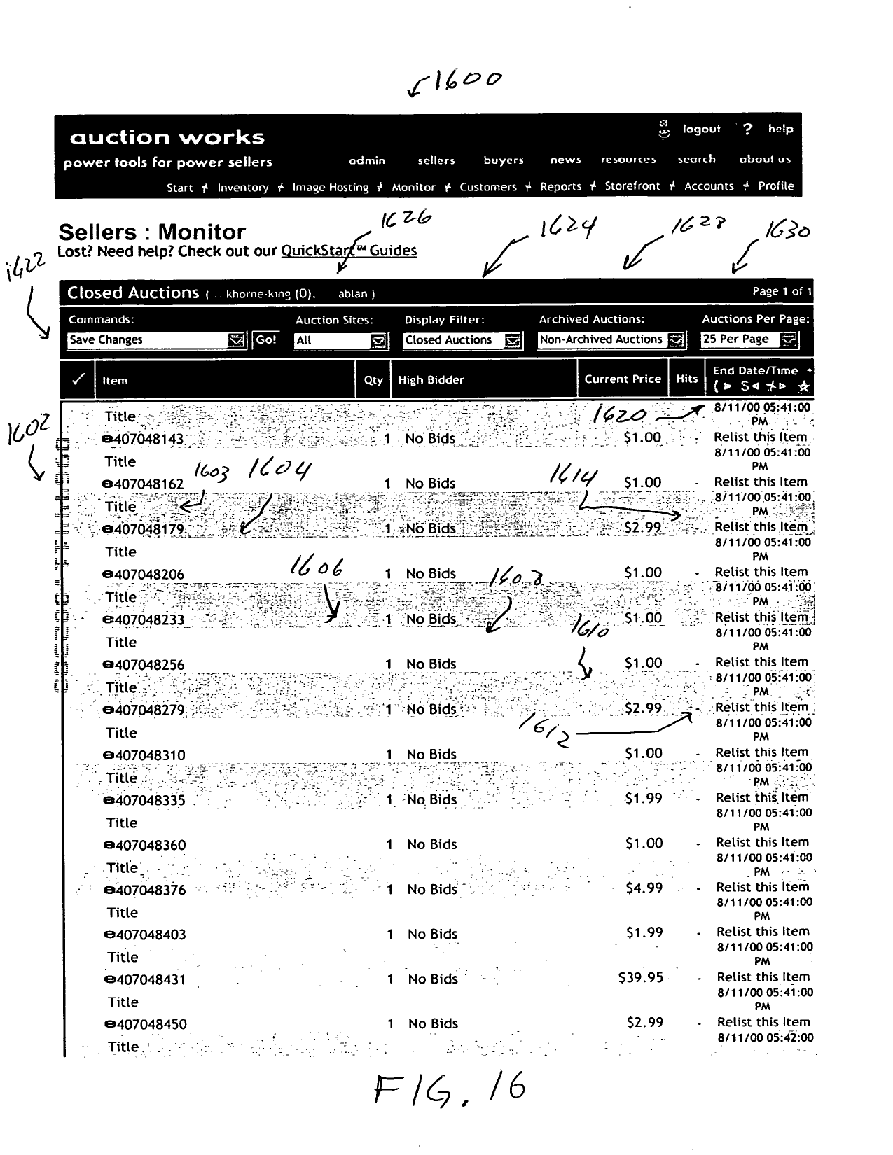

FIG. 16 is an illustration of a user interface containing a seller's auction monitoring report 1600. The report includes a consolidated set of records 1602 for each of the auctions associated with a particular account. Each record shows the item's title 1603, the item number 1604, the quantity offered for sale 1606, the high bidder 1608, the current price 1610 (i.e., highest bid if a bid has been received, or the minimum bid price if no bids have been received), the number of hits that the item's auction page has received 1612, and the auction end date and time 1614. Under the auction end date and time 1614 are tracking icons 1620.

These tracking icons include a first tracking icon (telephone) indicating whether the successful bidder has been notified, a second tracking icon ($) indicating whether payment has been received, a third tracking icon (plane) indicating whether the auction item has been shipped, and a fourth tracking icon (star) indicating whether feedback has been sent to the auction host. A user may select a particular auction record and then click on one or more of the tracking icons to enter indicators in tracking fields associated with that record. Each indicator typically appears as a bullet of check mark in that record row aligned in a column under the corresponding icon.

The auction monitoring report 1600 also includes a commands selection box 1622 that includes a selectable list of commands that may be activated for the report. The particular commands available within the commands selection box 1622 changes in response to the item selected in the display filter selection box 1624. The display filters selection box includes three choices: open auctions, pending auctions, and closed auctions. The open auctions are auctions that have been posted to an auction site and are currently active for receiving bids. The pending auctions are auctions that are queued for posting but have not yet been posted to an auction site. Closed auctions are auctions that have already closed. Selecting one of these filters causes only those auctions that fit the corresponding definition to be displayed within the auction monitoring report 1600.

The commands available for “open auctions” are: add counters, end auction early, import auction, invert selection, refresh page, select all, unselect all, and update auctions. The commands available for “pending auctions” are: invert selection, refresh page, select all, unselect all, cancel launch, and launch now. The commands available for “closed auctions” are: import auction, invert selection, refresh page, select all, unselect all, update auctions, archive item, save changes, delete auction, and resend notification to winning bidder.

The auction monitoring report 1600 also includes an auction sites selection item 1626, an archived auctions selection item 1628, and an auctions per page selection item 1630. The auction sites selection item 1626 allows the user to select one auction or all auction sites for display on the auction monitoring report 1600. The archived auctions selection item 1628 allows the user to select whether archived auctions are included on the auction monitoring report 1600. The auctions per page selection item 1630 allows the user to select the number of auction records displayed on each page of the auction monitoring report 1600.

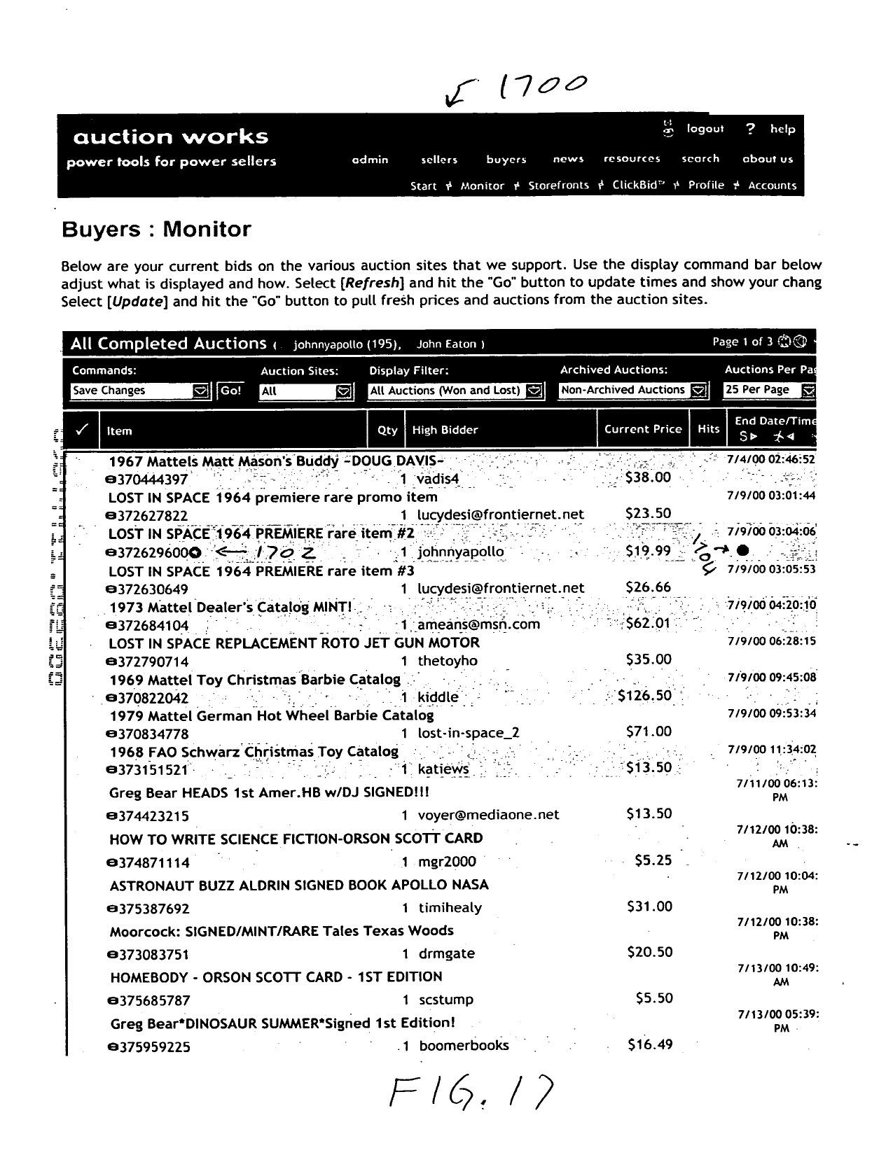

FIG. 17 is an illustration of a user interface containing a buyer's auction monitoring report 1700. The buyer's report is similar to the seller's monitoring report except that the available commands are somewhat different. The buyer's auction monitoring report 1700 also shows a feedback selection icon 1702 that appears next to the auction number in a closed auction record. Clicking on this icon launches an feedback window with some or all of the feedback items filled in with default settings. This allows the user to review and edit the feedback as desired. The buyer's auction monitoring report 1700 also shows a tracking field entry 1704 indicating that seller has already been notified of the closed auction.

The display filters selection box includes four choices: current bids, auctions won, auctions lost, and all auctions. The commands available for “current bids” are: invert selection, refresh page, and update auctions. The commands available for “auctions won” are: invert selection, refresh page, update auctions, archive auction, delete auction, select all, unselect all, and save changes. The same commands available for when the “lost auctions” and “all auctions” display filters are selected.

In view of the foregoing, it will be appreciated that present invention provides an auction management system that greatly facilitates auction processing and monitoring for multiple auctions posted on multiple auction sites. It should be understood that the foregoing relates only to the exemplary embodiments of the present invention, and that numerous changes may be made therein without departing from the spirit and scope of the invention as defined by the following claims.

1-26. (canceled)

27. A computer-readable medium storing computer-executable instructions for causing a computer-controlled apparatus to implement an auction management system, comprising:
an electronic auction monitoring report configured to display a plurality of auction management records within a common view, wherein each auction management record displays information pertaining to a respective auction submission and comprises tracking fields identifying post-sale activities to be performed in connection with the sale; and
an auction consolidation engine configured to post the auction submissions to one or more electronic auctions in accordance with the user-specified auction parameters, automatically revisit the auction sites, extract updated auction information pertaining to the auction submissions, update the auction monitoring report with the updated auction information, determine that a successful auction submission has resulted in a sale to a buyer, and update the auction management record for the successful auction submission with closed auction data associated with the sale.

28. The computer-readable medium of claim 27, wherein the auction monitoring report is comprises alterable tracking fields for indicating the status of post-sale activities associated with sales resulting form the auctions.

29. The computer-readable medium of claim 28, wherein the auction consolidation engine is configured to:
store settings data;
automatically perform a predefined post-sale operation in connection with the sale in accordance with the settings data associated with the auction management record for the successful auction submission; and
automatically display a corresponding tracking field in a state indicating completion of the post-sale operation.

30. The computer-readable medium of claim 29, wherein the predefined post-sale operation comprises sending a purchase notification message to the buyer.

31. The computer-readable medium of claim 29, wherein the predefined post-sale operation comprises sending an auction feedback message to a host of the auction that resulted in the sale.

32. A computer controlled apparatus comprising the computer-readable medium of claim 27.

33. A computer-readable medium storing computer-executable instructions for causing a computer-controlled apparatus to perform the steps of:
displaying an auction monitoring report comprising a plurality of auction management records displayed within a common view, wherein each auction management record displays information pertaining to a respective auction submission;
revisiting the auction sites to extract updated auction information pertaining to the auction submissions;
updating the auction monitoring report with the updated auction information;
determining that a successful auction submission has resulted in a sale to a buyer; and
updating the auction management record for the successful auction submission with closed auction data associated with the sale.

34. The computer-readable medium of claim 33, further comprising the steps of:
displaying tracking fields in association with the auction management record for the successful auction submission identifying post-sale activities to be performed in connection with the sale;
altering the view of the tracking fields to indicate completion of the associated post-sale activities.

35. The computer-readable medium of claim 34, further comprising the step of receiving user input altering the view of a selected tracking field to indicate completion of its associated post-sale activity.

36. The computer-readable medium of claim 34, further comprising the step of responding to the sale by:
storing settings data;
automatically performing a predefined post-sale operation in accordance with the settings data associated with the auction management record for the successful auction submission; and
automatically displaying a corresponding tracking field in a state indicating completion of the post-sale operation.

37. The computer-readable medium of claim 36, wherein the predefined post-sale operation comprises sending a purchase notification message to the buyer.

38. The computer-readable medium of claim 36, wherein the predefined post-sale operation comprises sending an auction feedback message to a host of the auction that resulted in the sale.

39. The computer-readable medium of claim 36, wherein the predefined post-sale operation comprises creating and storing a billing record containing the auction closed data.

40. The computer storage medium of claim 33, further comprising the step of revisiting the auction sites to extract updated auction information in response to a user request for access to the auction monitoring report.

41. The computer storage medium of claim 34, wherein each auction management record comprises a row displaying the information pertaining to its respective auction submission and the tracking fields are displayed as icons.

42. The computer storage medium of claim 34, wherein tracking fields include tracking fields for purchaser notification, payment received, auction item shipped, and payment received.

43. A computer controlled apparatus comprising the computer-readable medium of claim 33.
